(19) United States
(12) Patent Application Publication
(10) Pub. No.: US 2011/0243480 A1
(43) Pub. Date: Oct. 6, 2011

(54) Reusable Fabric Gift Bag With Reusable Fabric "Tissue" Wrapping

(76) Inventor: Jean Marie Cowman, (US)

(21) Appl. No.: 13/080,463

(22) Filed: Apr. 5, 2011

Related U.S. Application Data
(60) Provisional application No. 61/320,802, filed on Apr. 5, 2010.

(51) Int. Cl. B65D 33/06; B65D 30/04; B65D 30/10; B65D 30/16; B65D 65/02; B31B 1/00

(52) U.S. Cl. 383/6; 383/117; 383/121; 383/104; 150/154; 493/267

(57) ABSTRACT

This fabric gift bag with fabric tissue wrapping functions in the same manner as a paper gift bag with paper tissue wrapping. Use of this gift bag requires no tape, fasteners or special wrapping procedures of any sort. Gifts are simply placed into or wrapped with the optional fabric tissue wrapping and then placed inside the fabric gift bag. This fabric gift bag with optional fabric tissue wrapping can be re-used many times and cleaned as necessary (if washable or dry cleanable fabrics are used.) This reusable fabric gift bag with reusable fabric tissue wrapping eliminates waste and remanufacture of paper gift products.

### CROSS REFERENCE TO RELATED APPLICATIONS

This application references prior application No. 61/320,802

### REFERENCES CITED, [Referenced By]

U.S. Patent Documents

| | | |
|---|---|---|
| 4,777,066 | October 1988 | White et al. |
| D309257 | July 1990 | Myers |
| 5,004,144 | April 1991 | Selga |
| 5,161,895 | November 1992 | Myers |
| 5,186,988 | February 1993 | Dixon |
| D344451 | February 1994 | Suwa et al. |
| D350475 | September 1994 | Cirelli |
| 5,392,983 | February 1995 | Clarke-Bolling et al. |
| 5,407,125 | April 1995 | Yates et al. |
| D359452 | June 1995 | Hauck |
| 5,456,062 | October 1995 | Wechsler |
| 5,529,395 | June 1996 | French |
| D375896 | November 1996 | Martinson et al. |
| 5,634,317 | June 1997 | Bylenga |
| 5,709,068 | January 1998 | Bylenga |
| 5,720,557 | February 1998 | Simonsen |
| 5,743,458 | April 1998 | French |
| 5,788,067 | August 1998 | Marcellis |
| 5,850,963 | December 1998 | Chang |
| 5,904,289 | May 1999 | Hagan |
| 5,934,548 | August 1999 | Kenyon |
| 5,979,744 | November 1999 | Brigleb |
| 6,092,932 | July 2000 | Pekala et al. |
| D431002 | September 2000 | Bertozzi et al. |
| 6,126,054 | October 2000 | Riemer |
| 6,241,389 | June 2001 | Gilmore et al. |
| 6,647,697 | November 2003 | Zarrow et al. |
| D521393 | May 2006 | Pernell |
| D542150 | May 2007 | Bredbury |
| D561606 | February 2008 | Yang |

### BACKGROUND OF THE INVENTION

The present invention relates to a flexible bag with lifting or suspending elements (handles,) located at diverse bag regions (opposite top open edges of bag.) The bag has a flat, closed lower surface (opposite the open top edges) allowing the bag to stay upright when open or in use. A stabilizer is placed on the closed lower surface to make the lower surface more rigid for carrying heavier items and to retain bag shape.

Current paper gift bags and tissue paper marketed are disposable and create excessive waste. Manufacturing energy is also wasted with the need to keep replacing the disposable product. Potential creation of emissions or pollutants from paper manufacturing is also repeated while replacing the disposable product. This fabric gift bag with fabric tissue wrapping is reusable many times and eliminates paper waste and re-manufacture.

Prior art includes reusable fabric gift wrap. These reusable gift wraps require special folding, fasteners, flaps, sleeves, elastics, ties or elastic fabrics to encase the gift. Prior art also includes reusable gift bags that require special sleeves, drawcords, elastics, flaps, folds or require an elastic fabric that stretches around the gift.

This reusable fabric gift bag with optional reusable fabric “tissue” wrapping requires no special tape, folding, fasteners, flaps, sleeves, drawcords, elastics, ties or elastic fabrics. This reusable fabric gift bag requires only that the gift be placed inside of an appropriately sized gift bag, with or without the optional reusable fabric “tissue” wrapping. The end user has no special steps or instructions to follow to “wrap” the gift. This fabric gift bag with fabric “tissue” wrapping operates in the same manner as currently marketed paper gift bags with paper tissue wrapping, but lasts many times longer.

### BRIEF DESCRIPTION OF THE SEVERAL VIEWS OF THE DRAWING

FIG. 1 demonstrates the preferred method of assembly beginning with the fabric stabilizer placed along the top edge of the right side of the fabric 1. Fabric stabilizer 2 is shown with cross hatching. Dashed line 3 designates seam along top seam allowance.

FIG. 2 is a detailed partial view that illustrates the fabric 1 being folded to the outside of stabilizer 2. Note that raw edges of sides 4 are already finished or hemmed.

FIG. 3 depicts the stabilizer 2 stitched to the fabric 1 and then folded to form the side seam of the bag. Side seam placement 5 is denoted by a dashed line.

FIG. 4 shows bag folded for correct corner placement with 45 degree seams marked and stitched 6. Cross hatching on stabilizer 2 is omitted to clarify placement of 45 degree seams.

FIG. 5 shows lower bag surface seams 6 complete with excess fabric trimmed. Stabilizer 2 shows no cross hatching to clarify position of seams 6.

FIG. 6 shows the completed bag with fabric 1 side out and handles 7 attached. Visible inside the top of the bag are the stabilizer 2 (no cross hatching for clarification) and the pre made fabric “tissue” wrapping 8.

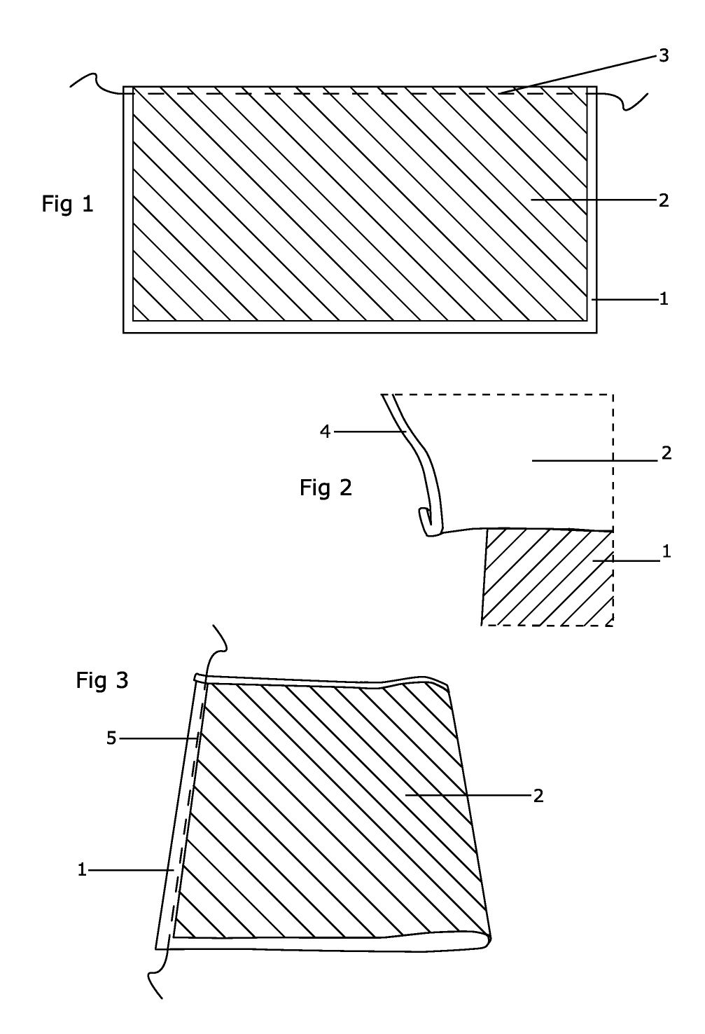

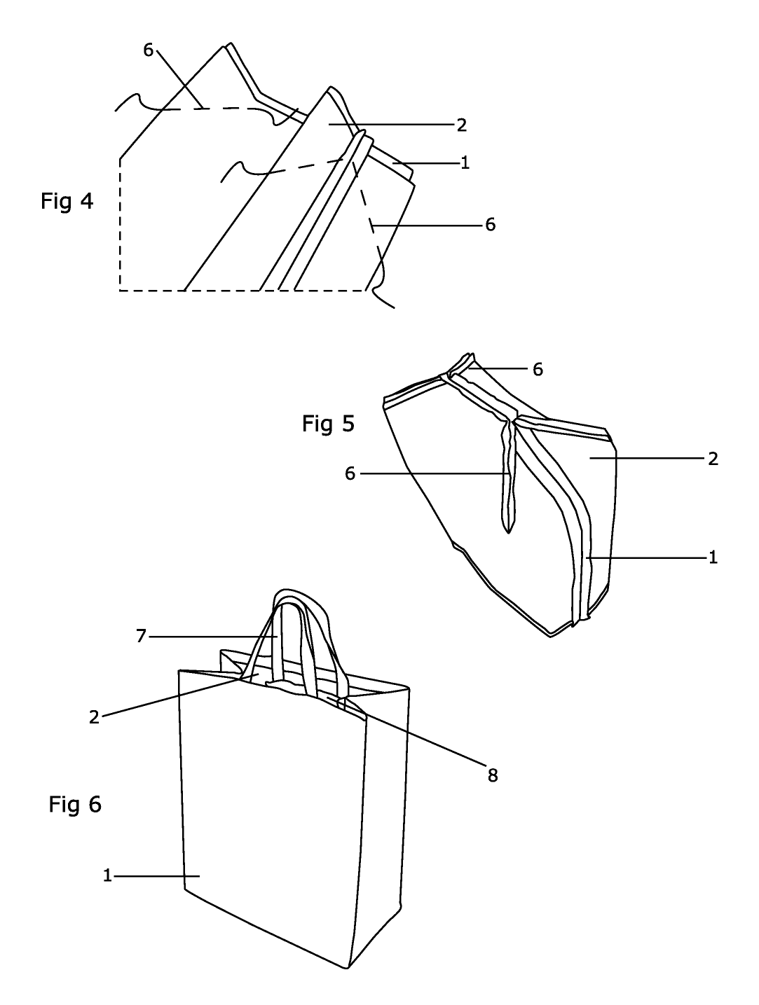

### DETAILED DESCRIPTION OF THE INVENTION

The product is comprised of the following components: Any suitable material can be used for the bag fabric which provides the decorative covering for the gift in the shape of a gift bag. Most decorator and quilting fabrics require an additional stiffener such as an iron on fusible stabilizer like Pellon Peltex 71F or a sew in stabilizer such as Pellon Peltex 70. This stabilizer is optional but helps the bag to retain its shape. (Many starches and applied stiffeners are water soluble and would have to be reapplied by the end user if the bag was to be washed or cleaned. Permanent washable stiffeners or stabilizers are recommended.) The bag can be formed using fabric glue or other methods of joining fabric, but sewn in seams are preferred.

Handles can be prepared to length out of a variety of materials including but not limited to ribbon, decorative cording, rope, decorative chains, braiding or fashioned from the cover fabric or any other suitable material. (Handle length can also vary according the size of the finished bag.) Rope, ribbon or fabric handles can be finished on raw ends with stitching, a washable fabric glue product or any other suitable finishing technique.

Fabric for the “tissue” wrapping can be of any type but lighter weight fabrics seem to drape around the gift(s) more easily. Edges of fabric wrapping can be finished with a variety of techniques including (but not limited to) narrow hemming, standard hemming, decorative binding, over edge stitching, zigzag (satin stitching) or raw fringed edges. Placing the gift in a fabric “tissue” wrapping before placing the gift in the gift bag is optional.

All decorations added to the finished bag are optional and plain bags can be produced so that end users can customize their own reusable bags. The finished bag can also be coated with sizing, starch or any other coating for shape retention, durability, water or stain repellency. Optional gift tags can be added to the finished bag.

Fabric to form the bag (or a composite of fabrics joined together to form one piece) is cut to the finished dimensions of the bag plus seam allowances. If fabric stabilizer is needed, cut stabilizer to the finished dimensions of the bag without seam allowances added. Finish raw edges of fabric on the sides that will form the side seam of the bag, (optional, but edges will show inside finished bag.)

Center top of stabilizer along top edge of fabric with right side of fabric facing stabilizer. With edges aligned and fabric centered, stitch along the seam allowance. Fold the right side of the fabric to the outside of the stabilizer. For an iron on stabilizer, align and press fabric to the stabilizer using recommended settings. For a sew in stabilizer, press top seam flat. Align and stitch sides and bottom of sew in stabilizer to fabric to ensure alignment. (Without stabilizer, use any method to finish raw edge along top of bag.)

Align and stitch side seam of the bag with right sides of the fabric together. (Stitch through the fabric only, along the edge of the stabilizer if stabilizer is used. This allows the finished bag to fold more easily.) Finish top seam corners to prevent loose threads or fraying (optional, but top seam corners will be visible inside of finished bag.) Press side seam flat if necessary.

If needed cut and prepare bottom stabilizer to fit inside the finished dimensions of the bag. Stabilizer can be made out of any sufficiently rigid material.

The preferred method for forming the bag's flat lower closure opposite the upper bag opening uses four 45 degree seams to produce a flat lower bag surface. Fold bag along side seam to mark the center of the opposite side of the bag. Use these center points to align bottom bag stabilizer (or a template) and mark bag corners. Press bag flat along all four marked corners and mark 45 degree bottom seams that will end at bottom seam allowance. Stitch all four 45 degree seams, ending each at bottom seam allowance. Trim corners and press seams open if necessary. Stitch final bottom seam, starting and stopping at intersection of 45 degree seams. Press final seam open and turn bag right side out.

Align and press bag flat. Add prepared handles and decorations (optional.) Cut fabric and finish edges (if necessary,) for the “tissue” wrapping.

Alternative constructions of this bag could use, but are not limited to using plastic sheeting, polyethylene, Mylar or any other reusable, decorative material that can be used in place of the fabric for the decorative bag material. The bottom bag stabilizer can be omitted if the bag fabric is rigid enough to hold the bags shape while containing a gift. Alternate lower bag closure configurations such as gathering, smocking, or milk carton or lunch bag style folds can be used and stitched into place, but these methods result in a bulkier and less flat lower surface. An alternate construction method that uses less fabric is to cut a lower bag face independent of the bag's side faces and stitch it to the side face(s) of the bag. The 45 degree seams are then no longer necessary, but a longer seam is required to join all four sides to the precut lower face, with or without the lower stabilizer added.

These reusable gift bags could alternately be used as reusable shopping bags, tote bags, decorative containers, storage bags, organizers for other objects, makeup bags or any other purpose requiring a hand bag.

1. This reusable fabric gift bag with optional reusable fabric wrapping functions in the same manner as currently marketed paper gift bags with paper tissue wrapping, but can be reused many times more than currently marketed paper gift bags with paper tissue wrapping, eliminating excessive waste and remanufacture of paper goods.

2. Bag has a closed lower face with an optional stabilizer placed in the bottom of the bag for carrying heavier items.

3. Bag has lifting or suspending elements (handles) located at diverse regions at top edges of bag.

4. Bag may be cleaned if constructed of a material that is washable or dry cleanable.

5. Gift can be encased in optional fabric “tissue” wrapping before being placed in bag.

6. Gift bag retains its shape when open or when containing a gift.

7. Gift bag is flexible and can be folded flat when not in use.

8. Gift(s) can be placed inside of the open (top) edge of fabric gift bag requiring no special wrapping procedures or use of any tape, ties, elastics, stretchy fabrics, cords or fasteners of any sort.

9. Top edge of bag with handles at diverse regions is left open requiring no sleeves, flaps or folds of fabric to contain or decorate the enclosed gift(s).

10. Fabric gift bag with optional fabric wrapping can be formed to correspond to any standard size gift bags already marketed or formed to correspond to any customized sizes.

11. The preferred method of constructing lower bag surface opposite of the upper open edges of bag is by placement of 45 degree seams allowing the lower bag surface to remain flat while bag is in use or folded for storage.

12. Alternate construction method of lower bag surface includes but is not limited to gathering, smocking, milk carton or lunch bag style folds, or cutting a separate lower fabric panel independent of the bag's side faces and then joining the lower panel to the side faces along their common border.

13. The lower face of the bag opposite the upper open edges could be but is not limited to an ovoid or circular shape as long as the lower face is a flat surface that joins the side(s) of the bag along their common border.
